(19) United States
(12) Patent Application Publication
(10) Pub. No.: US 2012/0048250 A1
(43) Pub. Date: Mar. 1, 2012

(54) METHOD FOR IGNITING AIR-FUEL MIXTURE THAT FILLS COMBUSTION SPACE PROVIDED IN COMBUSTION VESSEL OF INTERNAL COMBUSTION ENGINE

(75) Inventors: Kenjirou SHIMODA, Nagoya-City (JP); Wataru Shionoya, Okazaki-City (JP)

(73) Assignee: NGK Insulators, Ltd., Nagoya-City (JP)

(21) Appl. No.: 13/188,978

(22) Filed: Jul. 22, 2011

(30) Foreign Application Priority Data
Aug. 25, 2010 (JP) 2010-188083

(51) Int. Cl. F02P 15/08

(52) U.S. Cl. 123/636

(57) ABSTRACT

An electrode structure for a combustion vessel including a first electrode and a first dielectric barrier. The first electrode is made of a conductive material, has a rod-like shape, and protrudes from an inner surface of the combustion vessel. The first dielectric barrier is made of a dielectric material. The first electrode has, on its surface, a first exposed surface exposed in the combustion space and a first coated surface coated with the first dielectric barrier. A predischarge progresses while the first coated surface serves as a start point or an end point of the progress. A main discharge progresses while the first exposed surface serves as a start point or an end point of the progress. The main discharge includes a creeping discharge that creeps along a surface of the first dielectric barrier, and goes through a spatial region where the predischarge occurs.

### BACKGROUND OF THE INVENTION

1. Field of the Invention

The present invention relates to a method for igniting an air-fuel mixture that fills a combustion space provided in a combustion vessel of an internal combustion engine.

2. Description of the Background Art

In an internal combustion engine such as a vehicle engine, a spark plug that causes a discharge in a space between an anode and a cathode is widely used for igniting an air-fuel mixture.

In the spark plug, if the space between the anode and the cathode is widened, the discharge cannot be caused unless a voltage applied between the anode and the cathode is made higher. Depending on the composition, the pressure, and the like, of the air-fuel mixture, the discharge may occur at an undesirable timing or the spark plug may be damaged by an arc discharge, which deteriorates the stability of the discharge. The composition, the pressure, and the like, of the air-fuel mixture are not constant. The deterioration in the stability of the discharge impairs the stability of ignition of the air-fuel mixture.

However, if the space between the anode and the cathode is not widened, the discharge cannot largely spread in a three-dimensional manner, and thus a flame cannot largely spread in a three-dimensional manner, thus deteriorating a combustion rate and a combustion efficiency.

To solve this problem, Japanese Patent Application Laid-Open No. 1993-36463 proposes a spark plug in which an induction electrode (floating electrode 11) is provided in addition to an anode (center electrode 3) and a cathode (external electrode 6) to thereby widen a space between the anode and the cathode.

Although the spark plug disclosed in Japanese Patent Application Laid-Open No. 1993-36463 is useful, a structure located near the site of occurrence of a flame has a large heat capacity and therefore heat is likely to be extracted by the structure, which makes it difficult to improve the combustion rate and the combustion efficiency. Moreover, an increase in the pressure of an air-fuel mixture hinders a discharge.

### SUMMARY OF THE INVENTION

The present invention is directed to a method for igniting an air-fuel mixture that fills a combustion space provided in a combustion vessel of an internal combustion engine.

In a first aspect of the present invention, after an electrode structure is mounted in a combustion vessel, a predischarge and then a main discharge are generated. The electrode structure includes a first electrode and a first dielectric barrier. The first electrode is made of a conductive material, has a rod-like shape, and protrudes from an inner surface of the combustion vessel. The first dielectric barrier is made of a dielectric material. The first electrode has, on a surface thereof, a first exposed surface exposed in the combustion space and a first coated surface coated with the first dielectric barrier. The predischarge progresses while the first coated surface serves as a start point or an end point of the progress. The main discharge progresses while the first exposed surface serves as a start point or an end point of the progress. The main discharge includes a creeping discharge that creeps along a surface of the first dielectric barrier, and goes through a spatial region where the predischarge occurs.

In a second aspect of the present invention, some features are added to the first aspect of the present invention. In the second aspect of the present invention, the electrode structure further includes a second electrode, a third electrode and a second dielectric barrier. The second electrode and the third electrode are made of a conductive material. The second dielectric barrier is made of a dielectric material. The second electrode has, on a surface thereof, a second exposed surface exposed in the combustion space. The third electrode has, on a surface thereof, a second coated surface coated with the second dielectric barrier. The predischarge progresses between the first coated surface and the second coated surface. The main discharge progresses between the first exposed surface and the second exposed surface. The main discharge further includes a creeping discharge that creeps along a surface of the second dielectric barrier.

In a third aspect of the present invention, some features are added to the first aspect of the present invention. In the third aspect of the present invention, the electrode structure further includes a second electrode. The second electrode has, on a surface thereof, a second exposed surface exposed in the combustion space. The main discharge progresses between the first exposed surface and the second exposed surface. The predischarge progresses between the first coated surface and the second exposed surface.

In a fourth aspect of the present invention, some features are added to the first aspect of the present invention. In the fourth aspect of the present invention, the electrode structure further includes a second electrode and a second dielectric barrier. The second electrode has, on a surface thereof, a second exposed surface exposed in the combustion space and a second coated surface coated with the second dielectric barrier. The predischarge progresses between the first coated surface and the second coated surface. The main discharge further includes a creeping discharge that creeps along a surface of the second dielectric barrier. The main discharge progresses between the first exposed surface and the second exposed surface.

In a fifth aspect of the present invention, some features are added to the first aspect of the present invention. In the fifth aspect of the present invention, the electrode structure further includes a second electrode and a second dielectric barrier. The second electrode is made of a conductive material. The second dielectric barrier is made of a dielectric material. The combustion vessel has, on an inner surface thereof, a second exposed surface exposed in the combustion space. The second electrode has, on a surface thereof, a second coated surface coated with the second dielectric barrier. The predischarge progresses between the first coated surface and the second coated surface. The main discharge progresses between the first exposed surface and the second exposed surface. The main discharge includes a creeping discharge that creeps along a surface of the second dielectric barrier.

In a sixth aspect of the present invention, some features are added to the first aspect of the present invention. In the sixth aspect of the present invention, the combustion vessel has, on an inner surface thereof, a second exposed surface exposed in the combustion space. The predischarge progresses between the first coated surface and the second exposed surface. The main discharge progresses between the first exposed surface and the second exposed surface.

In the first to sixth aspects of the present invention, a stable discharge path for the main discharge is formed in the region where the predischarge occurs, and thus the main discharge stably occurs. The main discharge includes a creeping discharge which is not easily hindered even if the air-fuel mixture has a high pressure, thus allowing stable occurrence of the main discharge. Moreover, the main discharge largely spreads in a three-dimensional manner so that the amount of generated active species increases. Thus, a flame largely spreads in a three-dimensional manner, which improves the combustion rate and the combustion efficiency. Additionally, the heat capacity of a structure located near the site of occurrence of the main discharge is reduced, and therefore heat is not easily extracted by the structure, to improve the combustion rate and the combustion efficiency.

Desirably, the predischarge is a streamer discharge, and a main discharge is an arc discharge. This facilitates the formation of a stable discharge path, to make it easy to produce a strong flame.

Therefore, an object of the present invention is to provide a method for igniting the air-fuel mixture that fills the combustion space of the internal combustion engine, the method allowing stable occurrence of the discharge and improvement in the combustion rate and the combustion efficiency.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an electrode structure according to a first preferred embodiment;

FIG. 2 is a cross-sectional view showing a transition of a discharge according to the first preferred embodiment;

FIG. 3 is a cross-sectional view showing the transition of the discharge according to the first preferred embodiment;

FIG. 4 is a cross-sectional view showing the transition of the discharge according to the first preferred embodiment;

FIG. 5 is a perspective view showing an electrode structure according to a second preferred embodiment;

FIG. 6 is a perspective view showing an electrode structure according to a third preferred embodiment;

FIG. 7 is a perspective view showing an electrode structure according to a fourth preferred embodiment;

FIG. 8 is a cross-sectional view showing a transition of a discharge according to the fourth preferred embodiment;

FIG. 9 is a cross-sectional view showing, the transition of the discharge according to the fourth preferred embodiment;

FIG. 10 is a cross-sectional view showing the transition of the discharge according to the fourth preferred embodiment;

FIG. 11 is a perspective view showing an electrode structure according to a fifth preferred embodiment;

FIG. 12 is a cross-sectional view showing a transition of a discharge according to the fifth preferred embodiment;

FIG. 13 is a cross-sectional view showing the transition of the discharge according to the fifth preferred embodiment;

FIG. 14 is a cross-sectional view showing the transition of the discharge according to the fifth preferred embodiment;

FIG. 15 is a perspective view showing an electrode structure according to a sixth preferred embodiment;

FIG. 16 is a cross-sectional view showing a transition of a discharge according to the sixth preferred embodiment;

FIG. 17 is a cross-sectional view showing the transition of the discharge according to the sixth preferred embodiment;

FIG. 18 is a cross-sectional view showing the transition of the discharge according to the sixth preferred embodiment;

FIG. 19 is a perspective view showing an electrode structure according to a seventh preferred embodiment;

FIG. 20 is a cross-sectional view showing a transition of a discharge according to the seventh preferred embodiment;

FIG. 21 is a cross-sectional view showing the transition of the discharge according to the seventh preferred embodiment;

FIG. 22 is a cross-sectional view showing the transition of the discharge according to the seventh preferred embodiment;

FIG. 23 is a diagram schematically showing an ignition device according to an eighth preferred embodiment; and

FIG. 24 is a diagram schematically showing a pulse train.

### EMBODIMENT FOR CARRYING OUT THE INVENTION

### First Preferred Embodiment

A first preferred embodiment relates to a method for igniting an air-fuel mixture that fills a combustion space (combustion chamber) provided in a combustion vessel of an internal combustion engine, and also relates to an electrode structure used for the ignition.

(Electrode Structure)

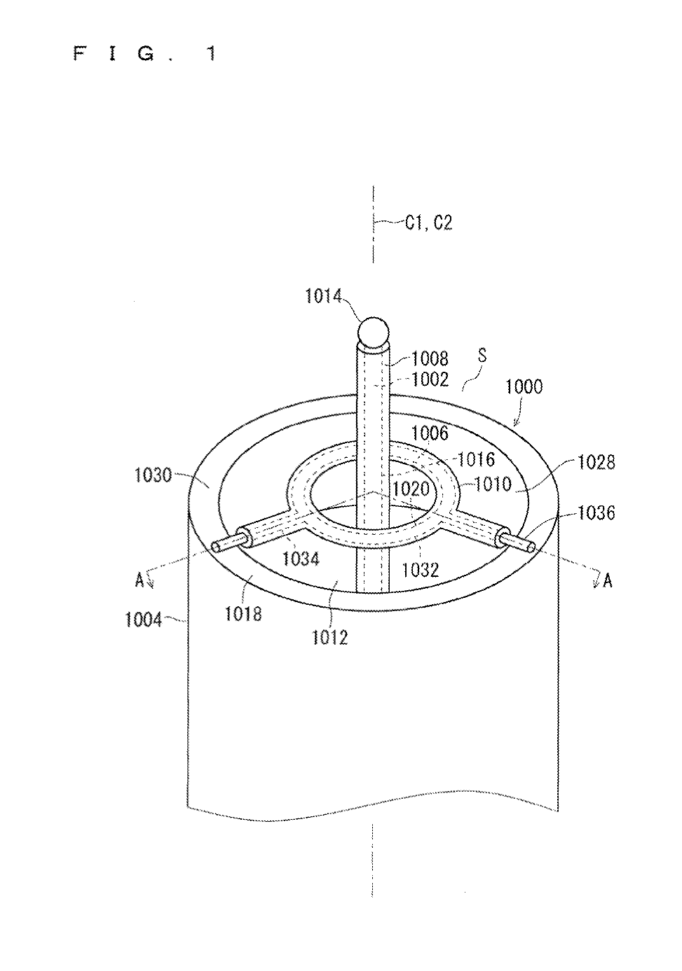

FIG. 1, is a diagram (perspective view) schematically showing an electrode structure according to the first preferred embodiment.

As shown in FIG. 1, an electrode structure 1000 includes an anode 1002, a cathode 1004, an induction electrode 1006, a anode coating 1008, an induction electrode coating 1010, and an anode supporter 1012. The anode 1002 has, on its surface, an exposed surface 1014 exposed in a combustion space S, and a coated surface 1016 coated with the anode coating 1008. The cathode 1004 has, on its surface, an exposed surface 1018 exposed in the combustion space S. The induction electrode 1006 has, on its surface, a coated surface 1020 coated with the induction electrode coating 1010.

The anode 1002 may be used as a cathode, and the cathode 1004 may be used as an anode. The start point and the end point of a discharge may be interchanged, and a direction of progress of the discharge may be changed. This applies commonly to all the preferred embodiments.

(Transition of Discharge)

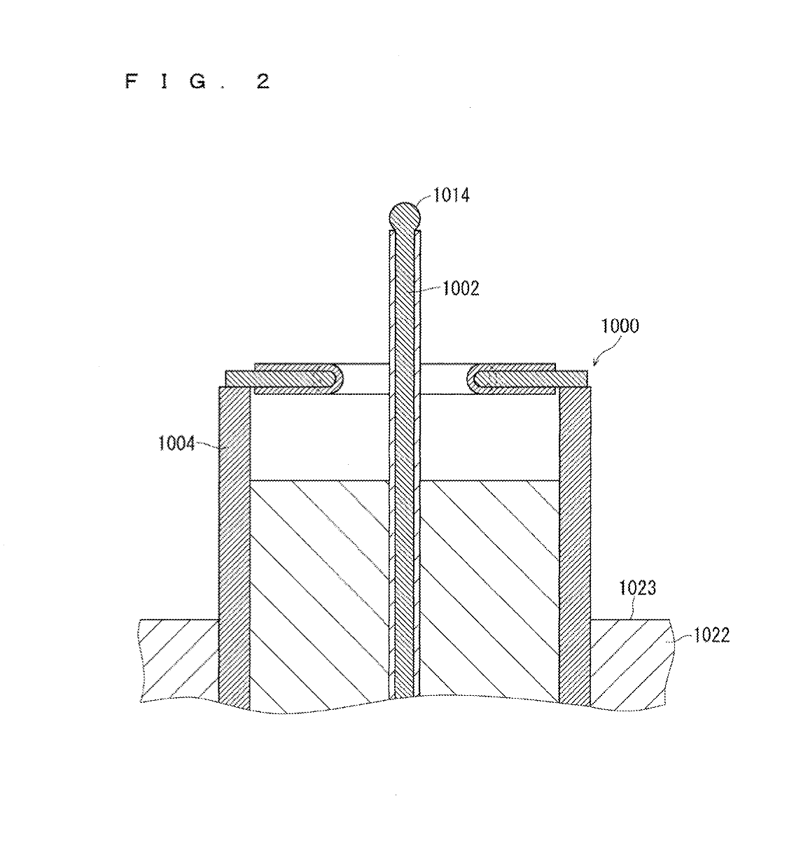

FIGS. 2 to 4 are diagrams (A-A cross-sectional views) schematically showing a transition of the discharge in a case where the electrode structure 1000 is used for ignition.

As shown in FIG. 2, similarly to the conventional spark plug, the electrode structure 1000 is mounted in a combustion vessel 1022. When the electrode structure 1000 is mounted in the combustion vessel 1022, the anode 1002 protrudes from an inner surface 1023 of the combustion vessel 1022 so that the exposed surface 1014 of the anode 1002 is located at a distance from the inner surface 1023 of the combustion vessel 1022. It is desirable that the cathode 1004 also protrudes from the inner surface 1023 of the combustion vessel 1022.

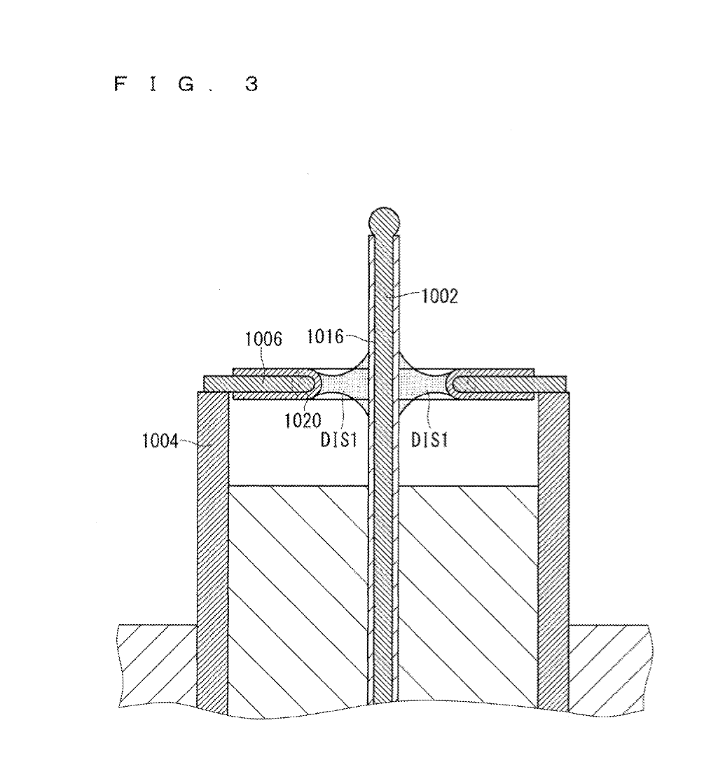

After the electrode structure 1000 is mounted in the combustion vessel 1022, a pulse voltage is applied between the anode 1002 and the cathode 1004 and thereby, as shown in FIG. 3, a predischarge DIS1 progressing from the coated surface 1016 of the anode 1002 to the coated surface 1020 of the induction electrode 1006 occurs between the coated surface 1016 of the anode 1002 and the coated surface 1020 of the induction electrode 1006. Subsequent to the occurrence of the predischarge DIS1, the application of the pulse voltage between the anode 1002 and the cathode 1004 is continued and, as shown in FIG. 4, a main discharge DIS2 progressing from the exposed surface 1014 of the anode 1002 to the exposed surface 1018 of the cathode 1004 occurs between the exposed surface 1014 of the anode 1002 and the exposed surface 1018 of the cathode 1004. In a normal case, the predischarge DIS1 and the main discharge DIS2 are repeatedly generated after the electrode structure 1000 is mounted in the combustion vessel 1022.

The main discharge DIS2 occurs after the occurrence of the predischarge DIS1 and before disappearance of a stable discharge path formed by the predischarge DIS1. This applies commonly to all the preferred embodiments.

The main discharge DIS2 progresses from the exposed surface 1014 of the anode 1002 along a surface 1024 of the anode coating 1008, goes through a spatial region R1 where the predischarge DIS1 occurs, and progresses along a surface 1026 of the induction electrode coating 1010, to reach the exposed surface 1018 of the cathode 1004. The main discharge DIS2 includes a creeping discharge CD1 creeping along the surface 1024 of the anode coating 1008 and a creeping discharge CD2 creeping along the surface 1026 of the induction electrode coating 1010. The main discharge DIS2 goes through the spatial region R1 where the predischarge DIS1 occurs. In this manner, the main discharge DIS2 includes the creeping discharges CD1 and CD2 which are not easily hindered even if the air-fuel mixture has a high pressure, thus allowing stable occurrence of the main discharge DIS2.

(Formation of Stable Discharge Path)

As shown in FIG. 1, the coated surface 1020 of the induction electrode 1006 is located closer to the coated surface 1016 of the anode 1002. The anode coating 1008 and the induction electrode coating 1010 are opposed to each other across the combustion space S. As a result, the anode coating 1008 and the induction electrode coating 1010 serve as a dielectric barrier, so that the predischarge DIS1 occurring at an initial stage upon the application of the pulse voltage between the anode 1002 and the cathode 1004 serves as a dielectric barrier discharge in the spatial region R1 interposed between the anode coating 1008 and the induction electrode coating 1010. The dielectric barrier discharge causes a plasma that produces active species to occur in the spatial region R1, to form a stable discharge path for the main discharge DIS2 in the spatial region R1. A part of the anode coating 1008 and a part of the induction electrode coating 1010 may be in contact with each other, as long as there is the spatial region R1 interposed between the anode coating 1008 and the induction electrode coating 1010.

Generally, a non-dielectric barrier discharge occurring between an exposed surface of one electrode and an exposed surface of the other electrode is likely to be influenced by the pressure, the composition, and the like, of an air-fuel mixture, and the occurrence thereof is not stable. However, in a case where the electrode structure 1000 is used for ignition, a stable discharge path for the main discharge DIS2 is formed in the spatial region R1 to allow stable occurrence of the main discharge DIS2 which is the non-dielectric harrier discharge.

The position of the stable discharge path depends on the position of the coated surface 1020 of the induction electrode 1006. Accordingly, in a case where the electrode structure 1000 is used for ignition, the discharge path for the main discharge DIS2 is determined depending on the position of the coated surface 1020 of the induction electrode 1006. If the discharge path for the main discharge DIS2 is controlled, the voltage at which the form of the discharge changes, the distance and the direction via which the discharge progress and the like are also controlled, to make it easy to generate discharge suitable for an internal combustion engine. This applies commonly to all the preferred embodiments.

(Form of Discharge)

It is desirable that the predischarge DIS1 is a streamer discharge, because the streamer discharge is suitable for formation of the stable discharge path for the main discharge DIS2. It is desirable that the main discharge DIS2 is an arc discharge, because the arc discharge is suitable for generation of a strong flame. Although the form of the discharge may slightly differ depending on the waveform of the pulse voltage and the composition, the pressure, and the like, of the air-fuel mixture, it is common that a relatively weak predischarge DIS1 is generated and then a relatively strong main discharge DIS2 is generated. This applies commonly to all the preferred embodiments.

(Anode and Anode Coating)

The anode 1002 has a rod-like shape, and protrudes from other structures such as an outer edge 1030 or an opening 1021 of the cathode 1004 and an anode supporter 1012. This allows the main discharge DIS2 to largely spread in a three-dimensional manner so that the amount of generated active species increases. Thus, the flame largely spreads in a three-dimensional manner, which improves the combustion rate and the combustion efficiency. Additionally, the heat capacity of a structure located near the site of occurrence of the main discharge DIS2 is reduced, and therefore heat is not easily extracted by the structure, to improve the combustion rate and the combustion efficiency. This allows an ignition suitable for lean combustion. Although the anode 1002 having a straight rod shape is shown in FIG. 1, the anode 1002 may have a curved rod shape.

The exposed surface 1014 of the anode 1002 is formed at a distal end portion of the anode 1002, and the coated surface 1016 of the anode 1002 is formed at a portion of the anode 1002 other than the distal end thereof. Therefore, the exposed surface 1014 of the anode 1002 is formed at a distance from the exposed surface 1018 of the cathode 1004, to allow the main discharge DIS2 to largely spread in a three-dimensional manner so that the amount of generated active species increases. Thus, the flame largely spreads in a three-dimensional manner, which improves the combustion rate and the combustion efficiency. If a slight reduction in the combustion rate and the combustion efficiency is permissible, the exposed surface 1014 of the anode 1002 may be formed at a portion other than the distal end portion of the anode 1002.

(Cathode)

The cathode 1004 has a tubular shape. It suffices that the cathode 1004 is configured to have an opening. The cathode 1004 protrudes from the anode supporter 1012.

The exposed surface 1018 of the cathode 1004 is arranged extensively on a surface of the cathode 1004. However, it suffices that the exposed surface 1018 of the cathode 1004 is formed in a region of the surface of the cathode 1004 corresponding to the end point of the discharge, that is, in a plane region of the surface of the cathode 1004 close to a portion connected to the induction electrode 1006. In a plane region of the surface of the cathode 1004 distant from the portion connected to the induction electrode 1006, either of the exposed surface and the coated surface may be formed.

(Induction Electrode and Induction Electrode Coating)

The induction electrode 1006 includes an induction part 1032 and a connection part 1034. The induction part 1032 is in the shape of a ring, and the connection part 1034 is in the shape of a straight rod. The connection part 1034 extends radially outward from the induction part 1032 to the outer edge 1030 of the opening 1028 of the cathode 1004.

The coated surface 1020 of the induction electrode 1006 is formed at the induction part 1032 and at a portion of the connection part 1034 other than a distal cnd portion thereof.

The exposed surface 1036 of the induction electrode 1006 is not coated with the induction electrode coating 1010. The exposed surface 1036 of the induction electrode 1006 is formed at the distal end portion of the connection part 1034, and connected to the outer edge 1030 of the opening 1028 of the cathode 1004. Thereby, the induction electrode 1006 is electrically connected to the cathode 1004, and mechanically held by the cathode 1004.

The induction electrode 1006 may be a floating electrode not electrically connected to the cathode 1004. Thus, the entire surface of the induction electrode 1006 may be coated with the induction electrode coating 1010. In a case where the entire surface of the induction electrode 1006 is coated with the induction electrode coating 1010, the induction electrode 1006 is not directly connected to the outer edge 1030 of the opening 1028 of the cathode 1004, but the induction electrode 1006 is connected to the outer edge 1030 of the opening 1028 of the cathode 1004 with interposition of the induction electrode coating 1010.

The induction electrode 1006 has a rod-like shape. This makes the heat capacity of the induction electrode 1006 small. Therefore, a small amount of heat is extracted by the induction electrode 1006. As a result, the combustion rate and the combustion efficiency are improved

(Material and Film Thickness)

The anode 1002, the cathode 1004, and the induction electrode 1006 are made of a conductive material. Desirably, the material of the anode 1002, the cathode 1004, and the induction electrode 1006 is selected from, for example, metals such as nickel (Ni), copper (Cu), tungsten (W), iridium (Ir), ruthenium (Rt), platinum (Pt), and yttrium (Y) and alloys of these metals.

The anode coating 1008 and the induction electrode coating 1010 is made of a dielectric material. Desirably, the material of the anode coating 1008 and the induction electrode coating 1010 is selected from, for example, ceramics such as alumina and resins such as a fluorine resin. The anode coating 1008 and the induction electrode coating 1010 are configured as films. The form of the predischarge DIS1, and the durability of the anode 1002 and the induction electrode 1010 are controlled based on the material and the film thickness of the anode coating 1008 and the induction electrode coating 1010. This applies commonly to all the preferred embodiments.

(improvement in Uniformity of Discharge)

Desirably, in the electrode structure 1000, portions corresponding to the start point and the end point of the discharge have a rotational symmetry with respect to a central axis. To be specific, the anode 1002 is in the shape of a straight rod, the cathode 1004 has the circular opening 1028, and the induction part 1032 of the induction electrode 1006 is in the shape of a circular ring. A central axis C1 of the cathode 1004 is coincident with a central axis C2 of the induction part 1032 of the induction electrode 1006. The anode supporter 1012 made of an insulating material supports the anode 1002 on the central axis C1 of the cathode 1004 and on the central axis C2 of the induction part 1032 of the induction electrode 1006. As a result, the predischarge DIS1 and the main discharge DIS2 have uniform discharge distances. Thus, the predischarge DIS1 and the main discharge DIS2 occur around the anode 1002 in a uniform manner. The shapes and the arrangement of the anode 1002, the cathode 1004, and the induction part 1032 of the induction electrode 1006 may be changed depending on, for example, the arrangement of the electrode structure 1000, a gas flow or the like in the combustion space S, and in a case where the combustion has a directivity.

### Second Preferred Embodiment

A second preferred embodiment relates to an electrode structure replacing the electrode structure according to the first preferred embodiment. The electrode structure according to the second preferred embodiment is different from the electrode structure according to the first preferred embodiment in terms of the structure of an induction electrode.

(Electrode Structure)

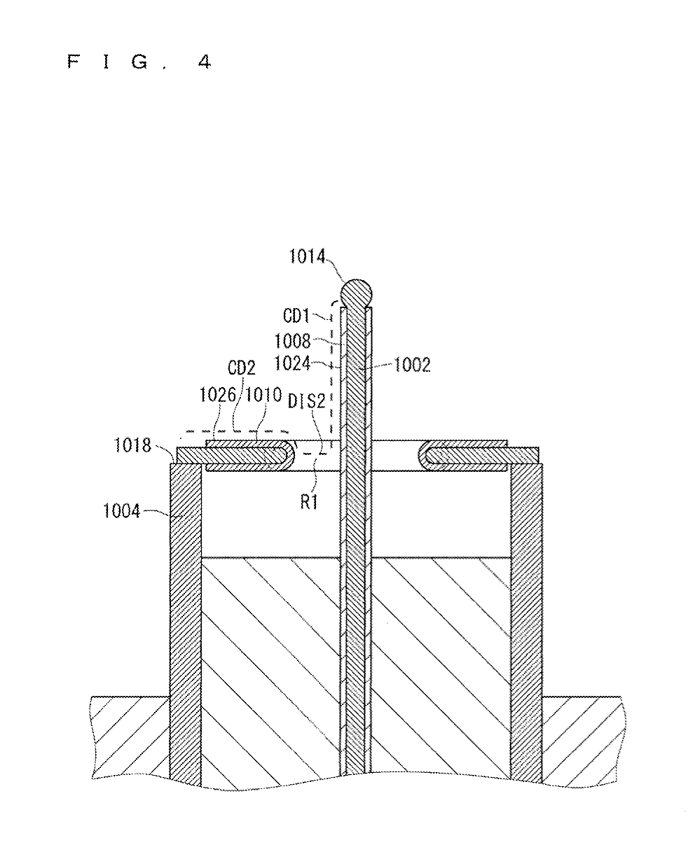

FIG. 5 is a diagram (perspective view) schematically showing an electrode structure 2000 according to the second preferred embodiment.

As shown in FIG. 5, the electrode structure 2000 includes an anode 2002, a cathode 2004, induction electrodes 2006, an anode coating 2008, an induction electrode coating 20W, and an anode supporter 2012. The anode 2002 has, on its surface, an exposed surface 2014 exposed in the combustion space S and a coated surface 2016 coated with the anode coating 2008. The cathode 2004 has, on its surface, an exposed surface 2018 exposed in the combustion space S. Each of the induction electrodes 2006 has, on its surface, a coated surface 2020 coated with the induction electrode coating 2010. The anode 2002, the cathode 2004, the anode coating 2008, and the anode supporter 2012 according to the second preferred embodiment are identical respectively to the anode 1002, the cathode 1004, the anode coating 1008, and the anode supporter 1012 according to the first preferred embodiment.

(Transition of Discharge)

Also in a case of using the electrode structure 2000, the electrode structure 2000 is mounted in a combustion vessel. When the electrode structure 2000 is mounted in the combustion vessel, the anode 2002 protrudes from an inner surface of the combustion vessel so that the exposed surface 2014 of the anode 2002 is located at a distance from the inner surface of the combustion vessel.

After the electrode structure 2000 is mounted in the combustion vessel, a pulse voltage is applied between the anode 2002 and the cathode 2004 and a predischarge progressing from the coated surface 2016 of the anode 2002 to the coated surface 2020 of the induction electrode 2006 occurs. The anode coating 2008 and the induction electrode coating 2010 function as a dielectric barrier, so that the predischarge serves as a dielectric barrier discharge. Subsequent to the occurrence of the predischarge, the application of the pulse voltage between the anode 2002 and the cathode 2004 is continued and a main discharge progressing from the exposed surface 2014 of the anode 2002 to the exposed surface 2018 of the cathode 2004 occurs. The main discharge includes a creeping discharge creeping along a surface 2028 of the anode coating 2008 and a creeping discharge creeping along a surface 2030 of the induction electrode coating 2010. The main discharge goes through a spatial region where the predischarge occurs.

(Induction Electrode and Induction Electrode Coating)

The induction electrode 2006 has a rod-like shape.

The coated surface 2020 of the induction electrode 2006 is formed at a portion other than both end portions of the induction electrode 2006.

An exposed surface 2022 of the induction electrode 2006 is not coated with the induction electrode coating 2010. The exposed surface 2022 of the induction electrode 2006 is formed at both end portions of the induction electrode 2006, and connected to an outer edge 2026 of an opening 2024 of the cathode 2004.

The induction electrode 2006 may be a floating electrode not electrically connected to the cathode 2004. Thus, the entire surface of the induction electrode 2006 may be coated with the induction electrode coating 2010.

(Improvement in Uniformity of Discharge)

Desirably, the induction electrode 2006 is in the shape of a straight rod. Thereby, the induction electrode 2006 has a simple structure, and makes the manufacturing of the electrode structure 2000 easy. One induction electrode 2006 and the other induction electrode 2006 are arranged in parallel with each other, and the anode supporter 2012 supports the anode 2002 at an intermediate position between one induction electrode 2006 and the other induction electrode 2006. As a result, the predischarge and the main discharge have uniform discharge distances. Thus, the predischarge and the main discharge occur around the anode 2002 in a uniform manner. If a slight reduction in the combustion rate and the combustion efficiency is permissible, the shapes and the arrangement of the anode 2002, the cathode 2004, and the induction electrode 2006 may be changed. The number of the induction electrodes 2006 may be one, or three or more.

(Experiment)

The discharge described in the section “Transition of Discharge” was generated by using the electrode structure according to the second preferred embodiment. Additionally, a discharge different from the discharge described in the section “Transition of Discharge” was generated in a state where the induction electrode was moved far from the anode. In the former case, even though the discharge continued for one minute or more, the electrode structure 2020 was not damaged. In the latter case, when a peak voltage of the pulse voltage reached 18 kV, an electrode structure was damaged.

### Third Preferred Embodiment

A third preferred embodiment relates to an electrode structure replacing the electrode structure according to the first preferred embodiment. The electrode structure according to the third preferred embodiment is different from the electrode structure according to the first preferred embodiment in terms of the entire structure.

(Electrode Structure)

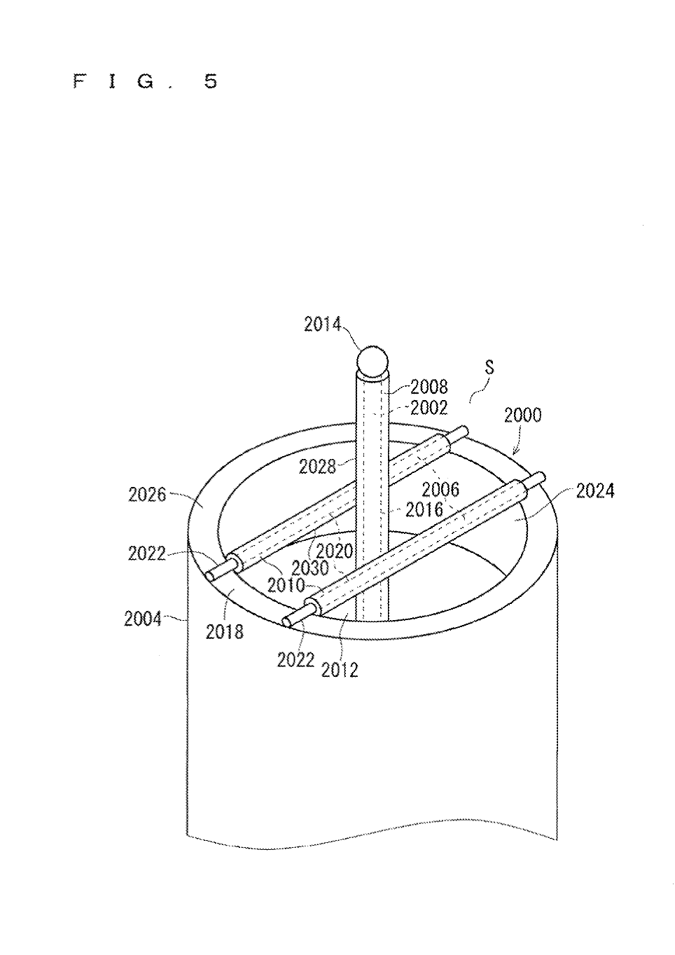

FIG. 6 is a diagram (perspective view) schematically showing an electrode structure according to the third preferred embodiment.

As shown in FIG. 6, an electrode structure 3000 includes an anode 3002, a cathode 3004, an induction electrode 3006, an anode coating 3008, and an induction electrode coating 3010. The anode 3002 has, on its surface, an exposed surface 3012 exposed in the combustion space S and a coated surface 3014 coated with the anode coating 3008. The cathode 3004 has, on its surface, an exposed surface 3016 exposed in the combustion space S. The induction electrode 3006 has, on its surface, a coated surface 3018 coated with the induction electrode coating 3010.

(Transition of Discharge)

Also in a case of using the electrode structure 3000, the electrode structure 3000 is mounted in a combustion vessel. When the electrode structure 3000 is mounted in the combustion vessel, the anode 3002 protrudes from an inner surface of the combustion vessel so that the exposed surface 3012 of the anode 3002 is located at a distance from the inner surface of the combustion vessel.

After the electrode structure 3000 is mounted in the combustion vessel, a pulse voltage is applied between the anode 3002 and the cathode 3004 and a predischarge progressing from the coated surface 3014 of the anode 3002 to the coated surface 3018 of the induction electrode 3006 occurs. The anode coating 3008 and the induction electrode coating 3010 function as a dielectric barrier, so that the predischarge serves as a dielectric barrier discharge. Subsequent to the occurrence of the predischarge, the application of the pulse voltage between the anode 3002 and the cathode 3004 is continued and a main discharge progressing from the exposed surface 3012 of the anode 3002 to the exposed surface 3016 of the cathode 3004 occurs. The main discharge includes a creeping discharge creeping along a surface 3022 of the anode coating 3008 and a creeping discharge creeping along a surface 3024 of the induction electrode coating 3010. The main discharge goes through a region where the predischarge occurs.

(Anode and Anode Coating)

The anode 3002 has a rod-like shape, and protrudes from a mounting surface 3020 of the cathode 3004. This allows the main discharge to largely spread in a three-dimensional manner so that the amount of generated active species increases. Thus, the flame largely spreads in a three-dimensional manner, which improves the combustion rate and the combustion efficiency. Additionally, the heat capacity of a structure located near the site of occurrence of the main discharge is reduced, and therefore heat is not easily extracted by the structure, to improve the combustion rate and the combustion efficiency. Although the anode 3002 having a curved rod shape such as a circular arc shape or an arcuate shape is shown in FIG. 6, the anode 3002 may have a curved rod shape other than a circular arc shape, or may have a straight rod shape.

The exposed surface 3012 of the anode 3002 is formed at a midpoint portion of the anode 3002, and the coated surface 3014 of the anode 3002 is formed at a portion of the anode 3002 other than the midpoint portion. As a result, the exposed surface 3012 of the anode 3002 is at a distance from the mounting surface 3020 of the cathode 3004, to allow the main discharge to largely spread in a three-dimensional manner so that the amount of generated active species increases. Thus, the flame largely spreads in a three-dimensional manner, which improves the combustion rate and the combustion efficiency.

(Cathode)

The cathode 3004 is configured to have the mounting surface 3020.

The exposed surface 3016 of the cathode 3004 is arranged extensively on a surface of the cathode 3004. However, it suffices that the exposed surface 3016 is formed in a region of the surface of the cathode 3004 corresponding to the end point of the discharge, that is, in a region close to a portion connected to the induction electrode 3006. In a region of the surface of the cathode 3004 distant from the portion connected to the induction electrode 3006, either of the exposed surface and the coated surface may be formed.

(Induction Electrode)

The induction electrode 3006 has a rod-like shape. The induction electrode 3006 extends along the portion of the anode 3002 other than the midpoint portion. Desirably, the induction electrode 3006 extends while keeping a constant distance from the portion of the anode 3002 other than the midpoint portion. This results in a uniform discharge distance, thus improving the uniformity of the predischarge and the main discharge. The induction electrode 3006 may have a curved rod shape other than a circular arc shape, or may have a straight rod shape.

The coated surface 3018 of the induction electrode 3006 is formed at a portion other than a root portion.

### Fourth Preferred Embodiment

A fourth preferred embodiment relates to a method for igniting an air-fuel mixture that fills a combustion space provided in a combustion vessel of an internal combustion engine, and also relates to an electrode structure used for the ignition. An electrode structure according to the fourth preferred embodiment is identical to the electrode structure according to the third preferred embodiment, except that the induction electrode and the induction electrode coating are not provided. In the ignition method according to the fourth preferred embodiment, the end point of the predischarge is located at the exposed surface of the cathode.

(Electrode Structure)

FIG. 7 is a diagram (perspective view) schematically showing an electrode structure according to the fourth preferred embodiment.

As shown in FIG. 7, an electrode structure 4000 includes an anode 4002, a cathode 4004, and an anode coating 4006. The anode 4002 has, on its surface, an exposed surface 4008 exposed in the combustion space S and a coated surface 4010 coated with the anode coating 4006. The cathode 4004 has, on its surface, an exposed surface 4012 exposed in the combustion space S. The anode 4002, the cathode 4004, and the anode coating 4006 according to the fourth preferred embodiment are identical respectively to the anode 3002, the cathode 3004, and the anode coating 3008 according to the third preferred embodiment.

The induction electrode 3006 and the induction electrode coating 3010 may not be provided in the electrode structure 3000 according to the third preferred embodiment, and in the same manner, the induction electrode 1006 and the induction electrode coating 1010 may not be provided in the electrode structure 1000 according to the first preferred embodiment, and the induction electrode 2006 and the induction electrode coating 2010 may not be provided in the electrode structure 2000 according to the second preferred embodiment.

(Transition of Discharge)

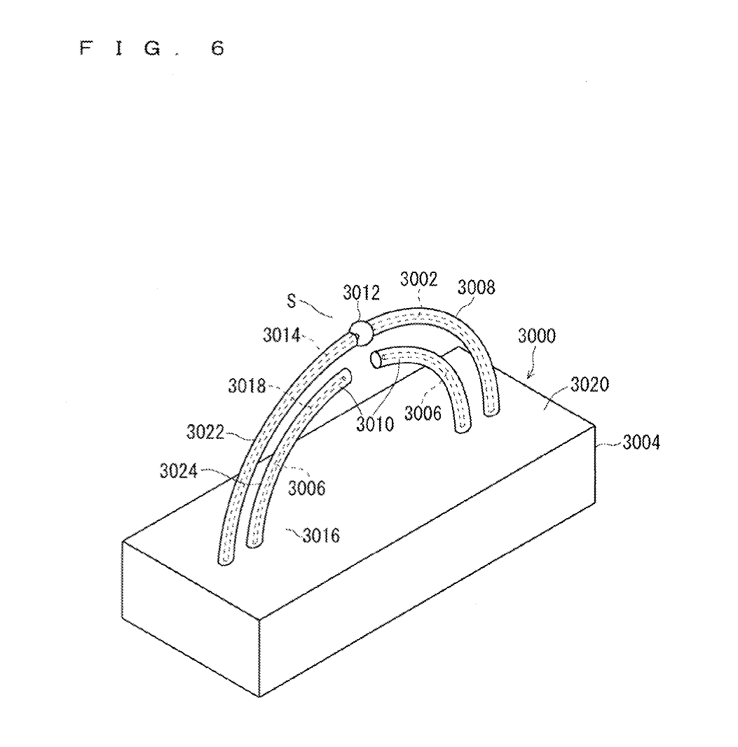

FIGS. 8 to 10 are diagrams (cross-sectional views) schematically showing a transition of a discharge in a case where the electrode structure 4000 is used for the ignition.

As shown in FIG. 8, the electrode structure 4000 is mounted in a combustion vessel 4014. When the electrode structure 4000 is mounted in the combustion vessel 4014, the anode 4002 protrudes from an inner surface 4015 of the combustion vessel 4014 so that the exposed surface 4008 of the anode 4002 is located at a distance from the inner surface 4015 of the combustion vessel 4014.

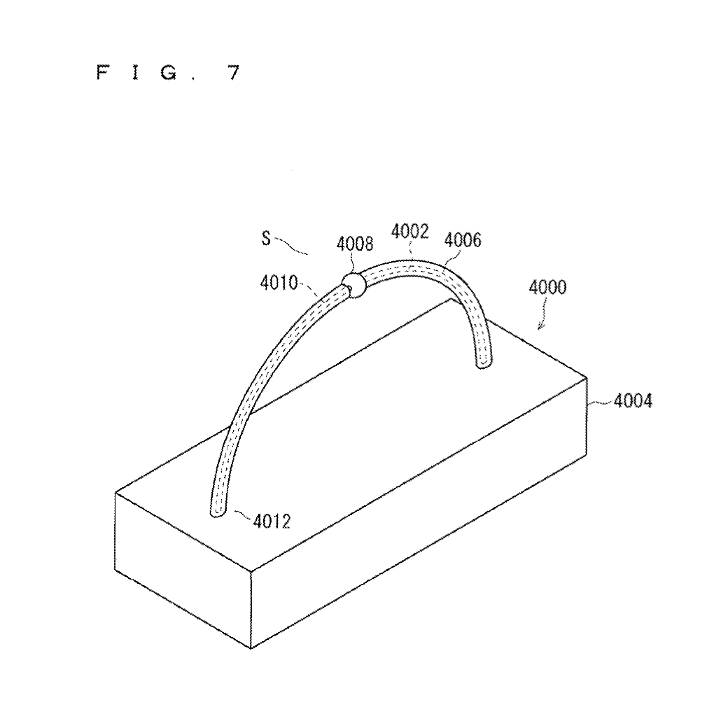

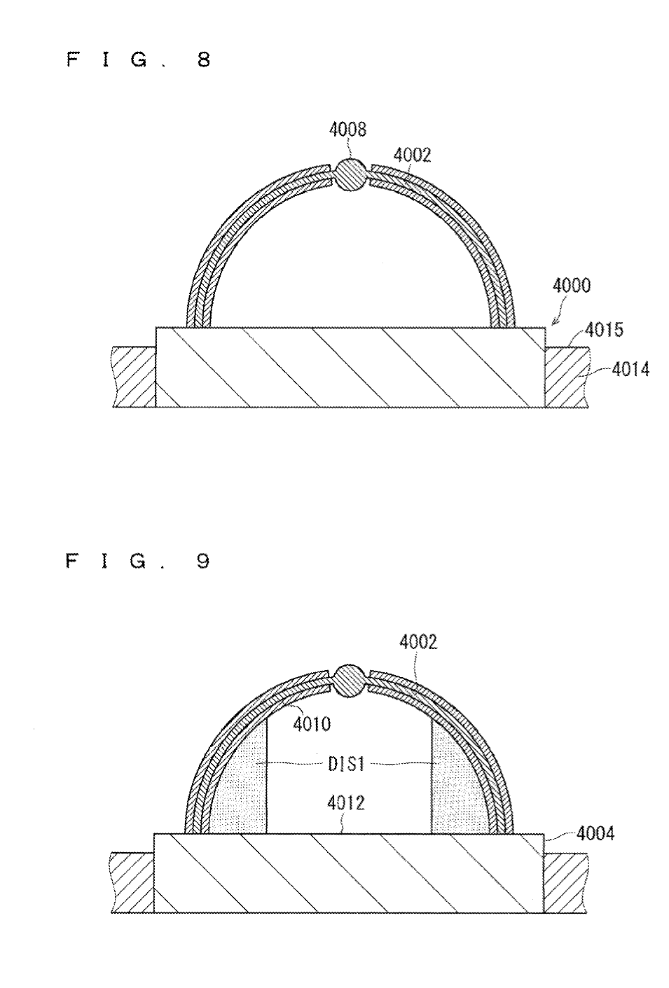

After the electrode structure 4000 is mounted in the combustion vessel 4014, a pulse voltage is applied between the anode 4002 and the cathode 4004 and thereby, as shown in FIG. 9, a predischarge DIS1 progressing from the coated surface 4010 of the anode 4002 to the exposed surface 4012 of the cathode 4004 occurs. The anode coating 4006 functions as a dielectric barrier, so that the predischarge DIS1 serves as a dielectric barrier discharge. Subsequent to the occurrence of the predischarge DIS1, the application of the pulse voltage between the anode 4002 and the cathode 4004 is continued and, as shown in FIG. 10, a main discharge DIS2 progressing from the exposed surface 4008 of the anode 4002 to the exposed surface 4012 of the cathode 4004 occurs.

The main discharge DIS2 includes a creeping discharge CD1 creeping along a surface 4014 of the anode coating 4006, and goes through a spatial region R1 where the predischarge DIS1 occurs. In this manner, the main discharge DIS2 includes the creeping discharge CD1 which is not easily hindered even if the air-fuel mixture has a high pressure, thus allowing stable occurrence of the main discharge DIS2.

### Fifth Preferred Embodiment

A fifth preferred embodiment relates to a method for igniting an air-fuel mixture that fills a combustion space provided in a combustion vessel of an internal combustion engine, and also relates to an electrode structure used for the ignition. An electrode structure according to the fifth preferred embodiment is identical to the electrode structure according to the first preferred embodiment, except that the induction electrode and the induction electrode coating are not provided, that the structure of the cathode is changed, and that a cathode coating is provided. In the ignition method according to the fifth preferred embodiment, the end point of the predischarge is located at the coated surface of the cathode.

(Electrode Structure)

FIG. 11 is a diagram (perspective view) schematically showing an electrode structure according to the fifth preferred embodiment.

As shown in FIG. 11, an electrode structure 5000 includes an anode 5002, a cathode 5004, an anode coating 5006, a cathode coating 5008, and an anode supporter 5010. The anode 5002 has, on its surface, an exposed surface 5012 exposed in the combustion space S and a coated surface 5014 coated with the anode coating 5006. The cathode 5004 has, on its surface, an exposed surface 5016 exposed in the combustion space S and a coated surface 5018 coated with the cathode coating 5008. The anode 5002, the anode coating 5006, and the anode supporter 5010 according to the fifth preferred embodiment are identical respectively to the anode 1002, the anode coating 1008, and the anode supporter 1012 according to the first preferred embodiment.

(Transition of Discharge)

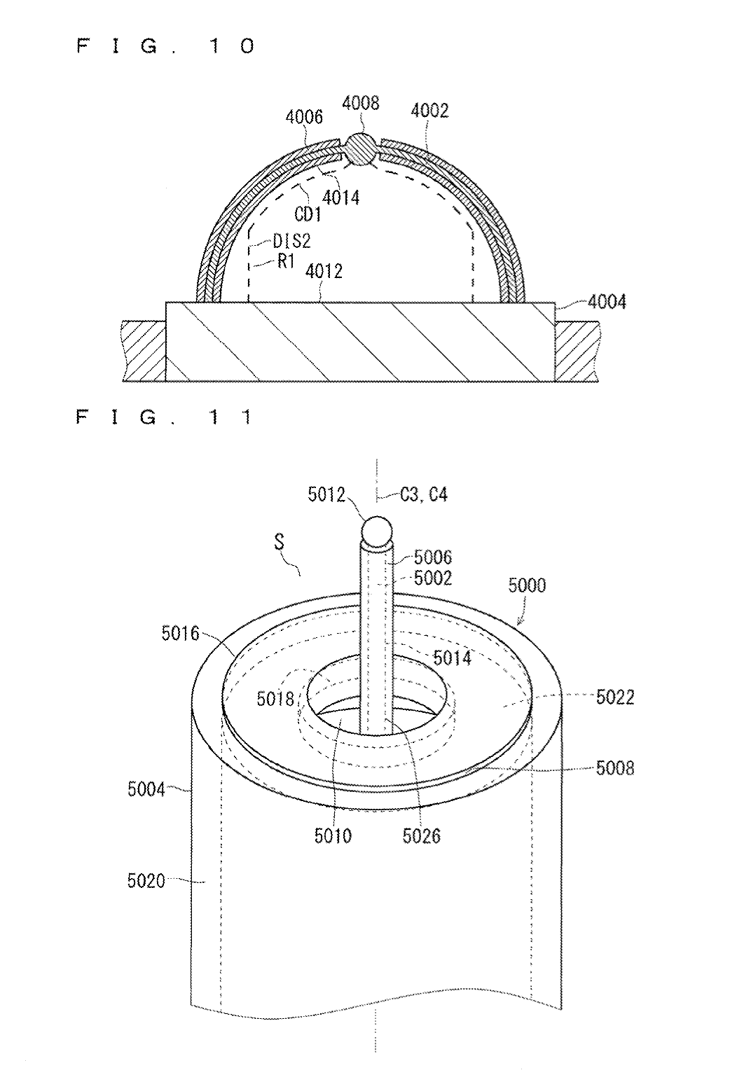

FIGS. 12 to 14 are diagrams (cross-sectional views) schematically showing a transition of a discharge in a case where the electrode structure 5000 is used for the ignition.

As shown in FIG. 12, the electrode structure 5000 is mounted in a combustion vessel 5024. When the electrode structure 5000 is mounted in the combustion vessel 5024, the anode 5002 protrudes from an inner surface 5025 of the combustion vessel 5024 so that the exposed surface 5012 of the anode 5002 is located at a distance from the inner surface 5025 of the combustion vessel 5024.

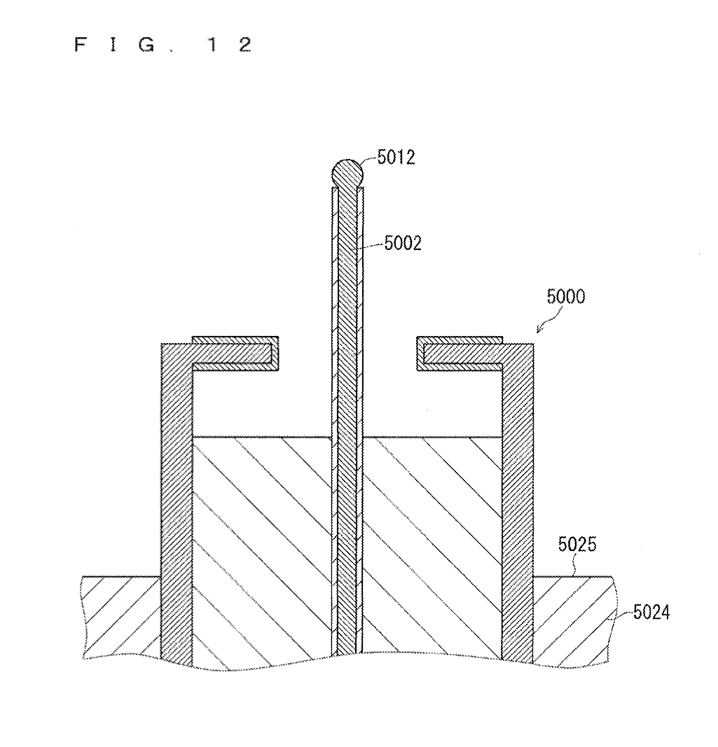

After the electrode structure 5000 is mounted in the combustion vessel 5024, a pulse voltage is applied between the anode 5002 and the cathode 5004 and thereby, as shown in FIG. 13, a predischarge DIS1 progressing from the coated surface 5018 of the anode 5002 to the coated surface 5018 of the cathode 5004 occurs. The anode coating 5006 and the cathode coating 5008 function as a dielectric barrier, so that the predischarge DIS1 serves as a dielectric barrier discharge. Subsequent to the occurrence of the predischarge DIS1, the application of the pulse voltage between the anode 5002 and the cathode 5004 is continued and, as shown in FIG. 14, a main discharge DIS2 progressing from the exposed surface 5012 of the anode 5002 to the exposed surface 5016 of the cathode 5004 occurs.

The main discharge DIS2 includes a creeping discharge CD1 creeping along a surface 5026 of the anode coating 5006 and a creeping discharge CD2 creeping along a surface 5028 of the cathode coating 5008. The main discharge DIS2 goes through a spatial region R1 where the predischarge DIS1 occurs. In this manner, the main discharge DIS2 includes the creeping discharges CD1 and CD2 which are not easily hindered even if the air-fuel mixture has a high pressure, thus allowing stable occurrence of the main discharge DIS2.

(Cathode and Cathode Coating)

As shown in FIG. 11, the cathode 5004 includes a main-body part 5020 and an induction part 5022. The main-body part 5020 has a tubular shape. The induction part 5022 has a flat ring shape or a flat washer shape. The induction part 5022 extends radially inward from the main-body part 5020. The coated surface 5018 of the cathode 5004 is located closer to the coated surface 5014 of the anode 5002.

The exposed surface 5016 of the cathode 5004 is arranged extensively on a surface of the main-body part 5020. However, it suffices that the exposed surface 5016 is formed in a region of the surface of the main-body part 5020 corresponding to the end point of the discharge, that is, in a region close to a portion connected to the induction part 5022. In a region of the surface of the cathode 5004 distant from the portion connected to the induction part 5022, either of the exposed surface and the coated surface may be formed.

The coated surface 5018 of the cathode 5004 is formed at the induction part 5022.

(Improvement in Uniformity of Discharge)

Desirably, the electrode structure 5000 has a rotational symmetry with respect to a central axis. To be specific, the anode 5002 has a straight rod shape, the main-body part 5020 of the cathode 5004 has a circular tube shape, and the induction part 5022 of the cathode 5004 has a circular opening. A central axis C3 of the main-body part 5020 of the cathode 5004 is coincident with a central axis C4 of the induction part 5022 of the cathode 5004. The anode supporter 5010 supports the anode 5002 on the central axis C3 of the main-body part 5020 of the cathode 5004 and on the central axis C4 of the induction part 5022 of the cathode 5004. As a result, the predischarge DIS1 and the main discharge DIS2 have uniform discharge distances. Thus, the predischarge DIS1 and the main discharge DIS2 occur around the anode 5002 in a uniform manner. If a slight reduction in the combustion rate and the combustion efficiency is permissible, the shapes and the arrangement of the anode 5002 and the cathode 5004 may be changed.

### Sixth Preferred Embodiment

A sixth preferred embodiment relates to a method for igniting an air-fuel mixture that fills a combustion space provided in a combustion vessel of an internal combustion engine, and also relates to an electrode structure used for the ignition. In the sixth preferred embodiment, the end point of the main discharge is located at an exposed surface of a combustion vessel.

(Electrode Structure)

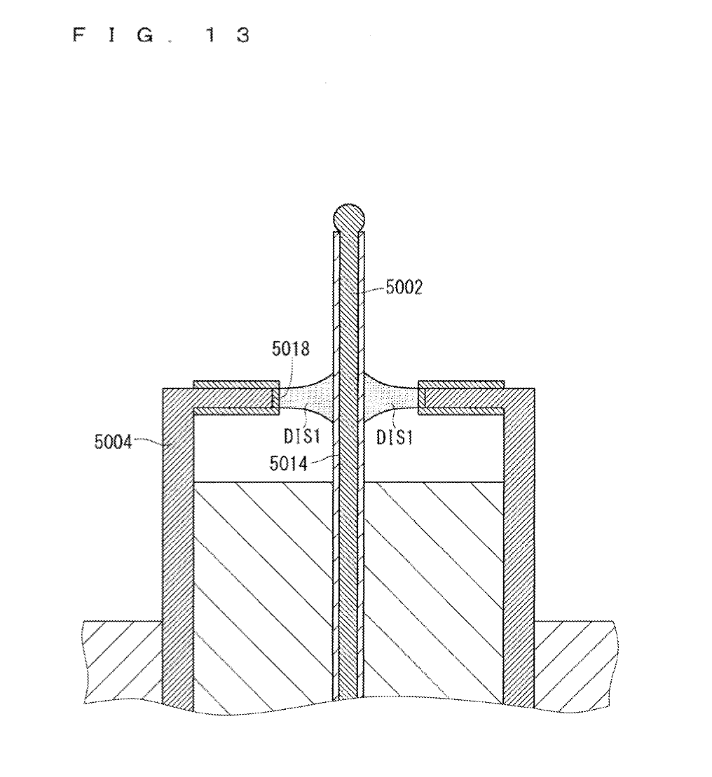

FIG. 15 is a diagram (perspective view) schematically showing an electrode structure according to the sixth preferred embodiment.

As shown in FIG. 15, an electrode structure 6000 includes an anode 6002, an induction electrode 6004, an anode coating 6006, and an induction electrode coating 6008. An combustion vessel 6010 is used as a cathode. The anode 6002 has, on its surface, an exposed surface 6012 exposed in the combustion space S and a coated surface 6014 coated with the anode coating 6006. The combustion vessel 6010 has, on its inner surface, an exposed surface 6016 exposed in the combustion space S. The induction electrode 6004 has, on its surface, a coated surface 6018 coated with the induction electrode coating 6008.

(Transition of Discharge)

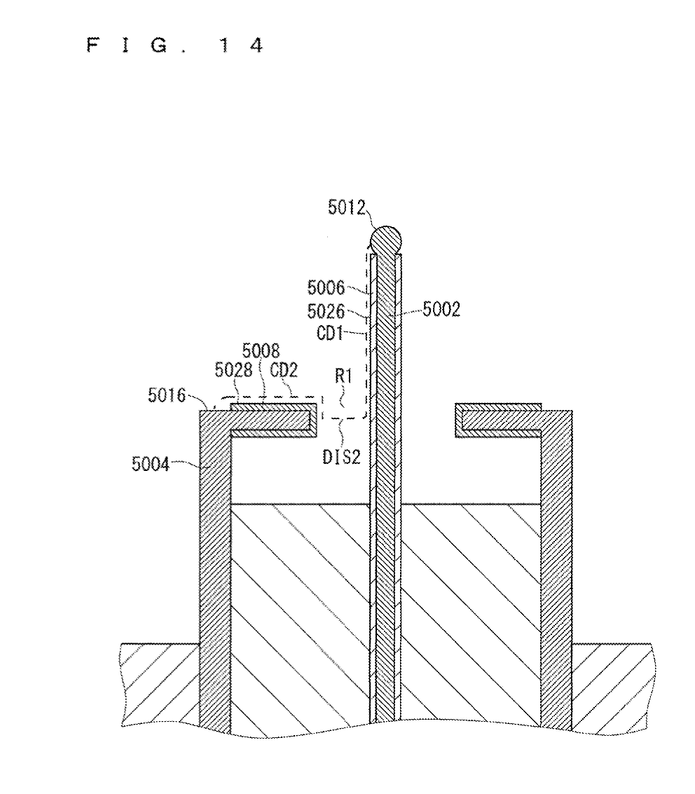

FIGS. 16 to 18 are diagrams (cross-sectional views) schematically showing a transition of a discharge in a case where the electrode structure 6000 is used for the ignition.

As shown in FIG. 16, the electrode structure 6000 is mounted in the combustion vessel 6010. When the electrode structure 6000 is mounted in the combustion vessel 6010, the anode 6002 protrudes from an inner surface 6024 of the combustion vessel 6010 and extends across the combustion space S, so that the exposed surface 6012 of the anode 6002 is located at a distance from the inner surface 6024 of the combustion vessel 6010.

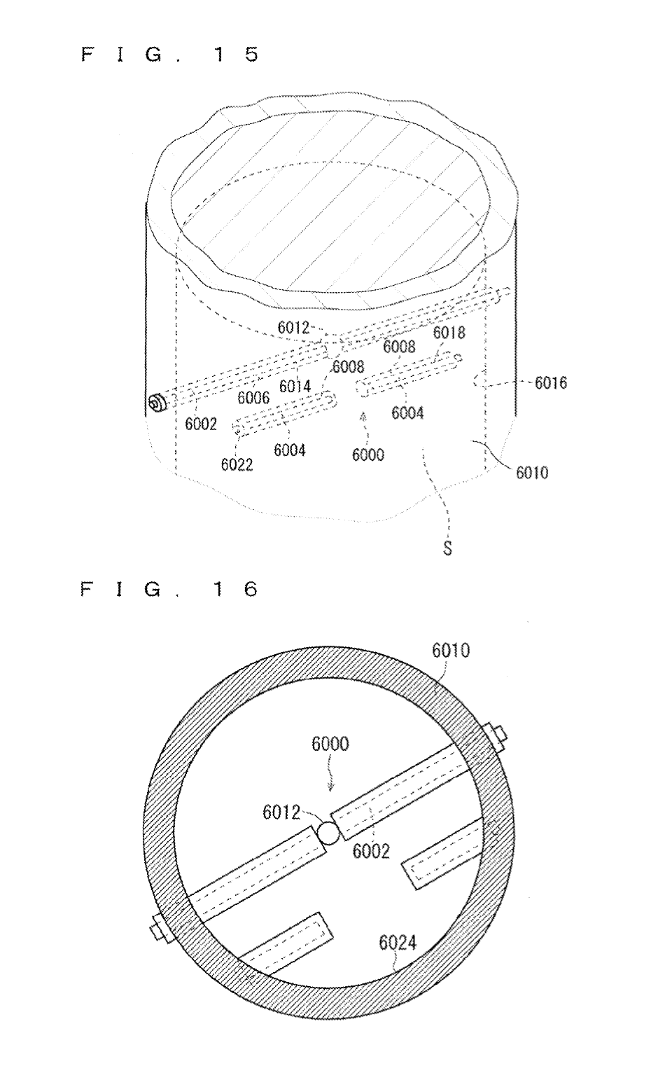

After the electrode structure 6000 is mounted in the combustion vessel 6010, a pulse voltage is applied between the anode 6002 and the combustion vessel 6010 and thereby, as shown in FIG. 17, a predischarge DIS1 progressing from the coated surface 6014 of the anode 6002 to the coated surface 6018 of the induction electrode 6004 occurs. The anode coating 6006 and the induction electrode coating 6008 function as a dielectric harrier, so that the predischarge DIS1 becomes a dielectric harrier discharge. Subsequent to the occurrence of the predischarge DIS1, as shown in FIG. 18, a main discharge DIS2 progressing from the exposed surface 6012 of the anode 6002 to the exposed surface 6016 of the combustion vessel 6010 occurs.

The main discharge DIS2 progresses from the exposed surface 6012 of the anode 6002 along a surface 6020 of the anode coating 6006, goes through a spatial region R1 where the predischarge DIS1 occurs, and progresses along a surface 6022 of the induction electrode coating 6008, to reach the exposed surface 6016 of the combustion vessel 6010. The main discharge DIS2 includes a creeping discharge CD1 creeping along the surface 6020 of the anode coating 6006 and a creeping discharge CD2 creeping along the surface 6022 of the induction electrode coating 6008. The main discharge DIS2 goes through the spatial region R1 where the predischarge DIS1 occurs. In this manner, the main discharge DIS2 includes the creeping discharges CD1 and CD2 which are not easily hindered even if an air-fuel mixture has a high pressure, thus allowing stable occurrence of the main discharge DIS2.

(Anode 6002)

The anode 6002 has a rod-like shape. The anode 6002 protrudes from the inner surface 6024 of the combustion vessel 6010. This allows the main discharge DIS2 to largely spread in a three-dimensional manner so that the flame largely spreads in a three-dimensional manner, which improves the combustion rate and the combustion efficiency. Additionally, the heat capacity of a structure located near the site of occurrence of the main discharge DIS2 is reduced, and therefore heat is not easily extracted by the structure, to improve the combustion rate and the combustion efficiency. Although the anode 6002 having a straight rod shape is shown in FIG. 15, the anode 6002 may have a curved rod shape.

The exposed surface 6012 of the anode 6002 is formed at a midpoint portion of the anode 6002, and the coated surface 6014 of the anode 6002 is formed at a portion of the anode 6002 other than the midpoint portion. As a result, the exposed surface 6012 of the anode 6002 is at a distance from the inner surface 6024 of the combustion vessel 6010, to allow the main discharge DIS2 to largely spread in a three-dimensional manner so that the flame largely spreads in a three-dimensional manner, which improves the combustion rate and the combustion efficiency.

(Induction Electrode 6004)

The induction electrode 6004 has a rod-like shape. The induction electrode 6004 extends along the portion of the anode 6002 other than the midpoint portion. Desirably, the induction electrode 6004 extends while keeping a constant distance from the portion of the anode 6002 other than the midpoint portion. This results in a uniform discharge distance, thus improving the uniformity of the predischarge DIS1 and the main discharge DIS2. Although the induction electrode 6004 having a straight rod shape is shown in FIG. 15, the induction electrode 6004 may have a curved rod shape.

The coated surface 6018 of the induction electrode 6004 is formed at a portion of the induction electrode 6004 other than a root portion thereof.

The exposed surface 6022 of the induction electrode 6004 is not coated with a dielectric coating. The exposed surface 6022 of the induction electrode 6004 is formed at the root portion of the induction electrode 6004, and connected to the inner surface 6016 of the combustion vessel 6010. Thereby, the induction electrode 6004 is electrically connected to the combustion vessel 6010, and mechanically held by the combustion vessel 6010.

The exposed surface 6022 of the induction electrode 6004 is formed at the root portion of the induction electrode 6004, for the purpose of the electrical connection of the induction electrode 6004 to the combustion vessel 6010. However, the induction electrode 6004 may be a floating electrode not electrically connected to the combustion vessel 6010. Thus, the entire surface of the induction electrode 6004 may be coated with the induction electrode coating 6008.

(Combustion Vessel 6010)

The combustion vessel 6010 is made of a conductive material. The exposed surface 6016 of the combustion vessel 6010 is arranged extensively on the inner surface 6016 of the combustion vessel 6010. However, it suffices that the exposed surface 6016 is formed in a region of the inner surface 6024 of the combustion vessel 6010 corresponding to the end point of the discharge, that is, in a region close to a portion connected to the induction electrode 6004. In a region of the inner surface of the combustion vessel 6010 distant from the portion connected to the induction electrode 6004, either of the exposed surface and the coated surface may be formed.

### Seventh Preferred Embodiment

A seventh preferred embodiment relates to a method for igniting an air-fuel mixture that fills a combustion space provided in a combustion vessel of an internal combustion engine, and also relates to an electrode structure used for the ignition. An electrode structure according to the seventh preferred embodiment is identical to the electrode structure according to the sixth preferred embodiment, except that the induction electrode is not provided. In the seventh preferred embodiment, the end point of the predischarge and the main discharge is located at an exposed surface of the combustion vessel.

(Electrode Structure)

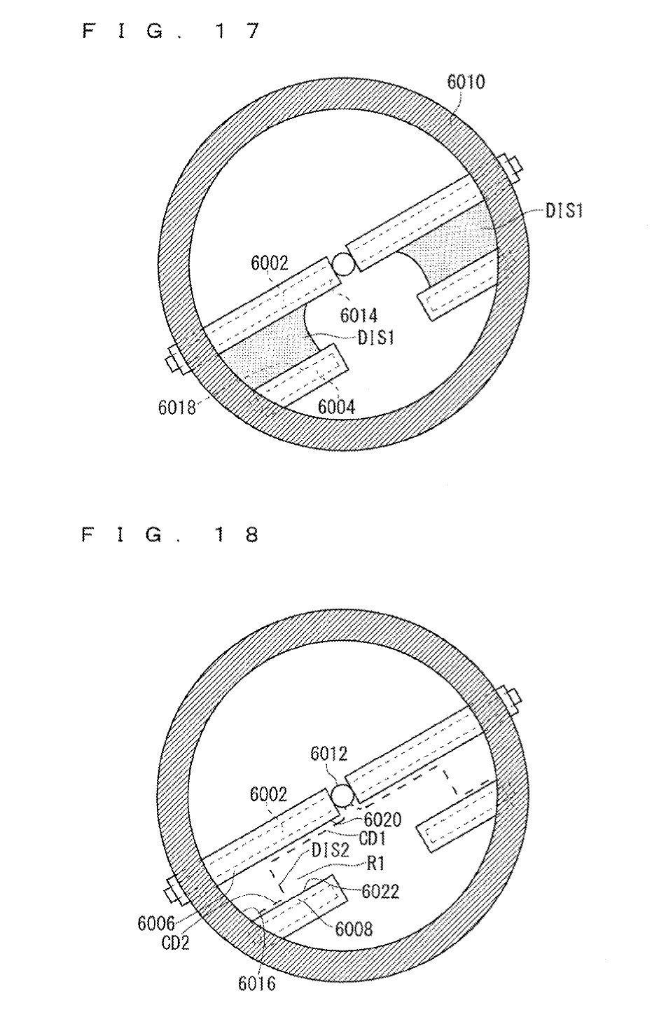

FIG. 19 is a diagram (perspective view) schematically showing an electrode structure according to the seventh preferred embodiment.

As shown in FIG. 19, an electrode structure 7000 includes an anode 7002 and an anode coating 7004. A combustion vessel 7010 is used as a cathode. The anode 7002 has, on its surface, an exposed surface 7006 exposed in the combustion space S and a coated surface 7008 coated with the anode coating 7004. The combustion vessel 7010 has, on its inner surface, an exposed surface 7012 exposed in the combustion space S. The anode 7002 and the anode coating 7004 according to the seventh preferred embodiment are identical respectively to the anode 6002 and the anode coating 6006 according to the sixth preferred embodiment.

(Transition of Discharge)

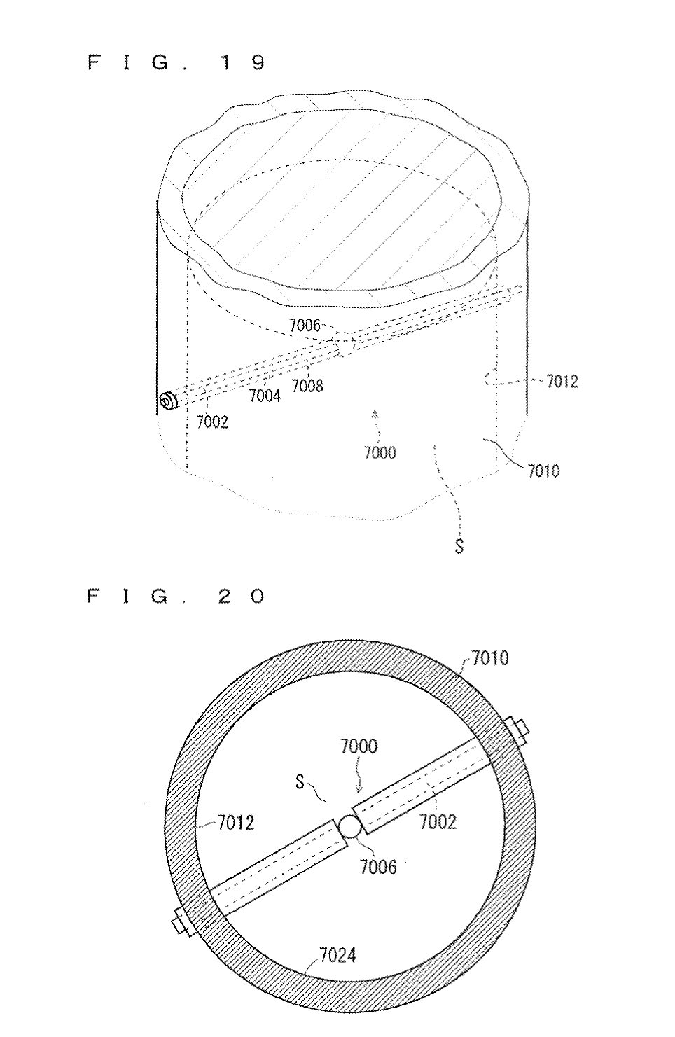

FIGS. 20 to 22 are diagrams (cross-sectional views) schematically showing a transition of a discharge in a case where the electrode structure 7000 is used for the ignition.

As shown in FIG. 20, the electrode structure 7000 is mounted in the combustion vessel 7010. When the electrode structure 7000 is mounted in the combustion vessel 7010, the anode 7002 protrudes from the inner surface 7024 of the combustion vessel 7010 and extends across the combustion space S, so that the exposed surface 7006 of the anode 7002 is located at a distance from the inner surface 7024 of the combustion vessel 7010.

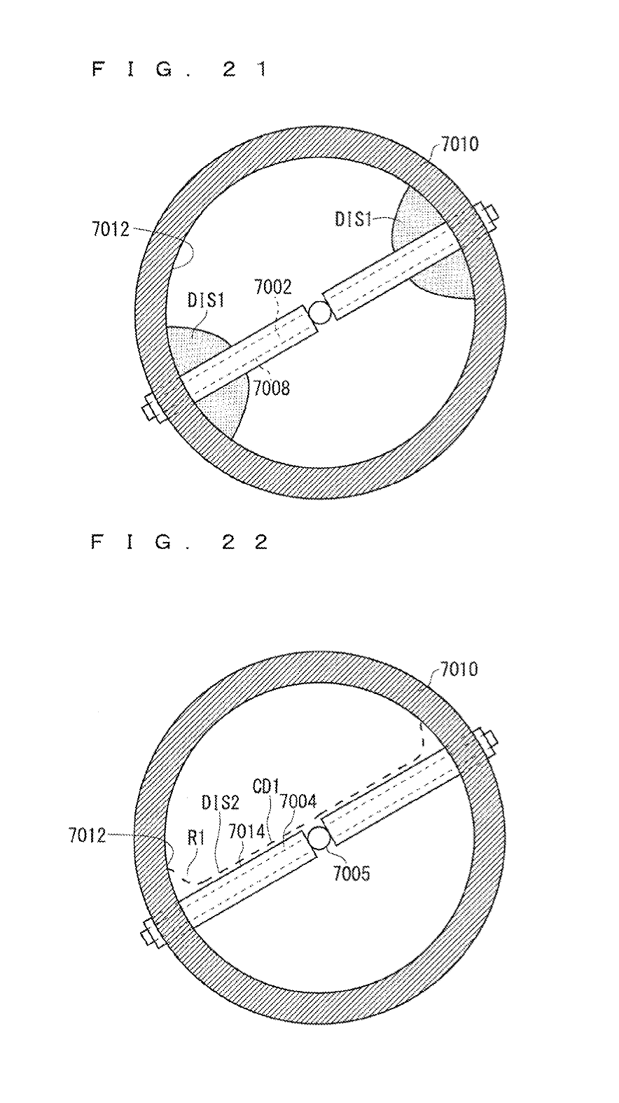

After the electrode structure 7000 is mounted in the combustion vessel 7010, a pulse voltage is applied between the anode 7002 and the combustion vessel 7010 made of a conductive material and thereby, as shown in FIG. 21, a predischarge DIS1 progressing from the coated surface 7006 of the anode 7002 to the exposed surface 7012 of the combustion vessel 7010 occurs. The anode coating 7004 functions as a dielectric barrier, so that the predischarge DIS1 serves as a dielectric barrier discharge. Subsequent to the occurrence of the predischarge DIS1, as shown in FIG. 22, a main discharge DIS2 progressing from the exposed surface 7006 of the anode 7002 to the exposed surface 7012 of the combustion vessel 7010 occurs.

The main discharge DIS2 includes a creeping discharge CD1 creeping along a surface 7014 of the anode coating 7004, and goes through a spatial region R1 where the predischarge DIS1 occurs. In this manner, the main discharge DIS2 includes the creeping discharge CD1 which is not easily hindered even if the air-fuel mixture has a high pressure, thus allowing stable occurrence of the main discharge DIS2.

### Eighth Preferred Embodiment

An eighth preferred embodiment relates to an ignition device for igniting an air-fuel mixture that fills a combustion space provided in a combustion vessel of an internal combustion engine.

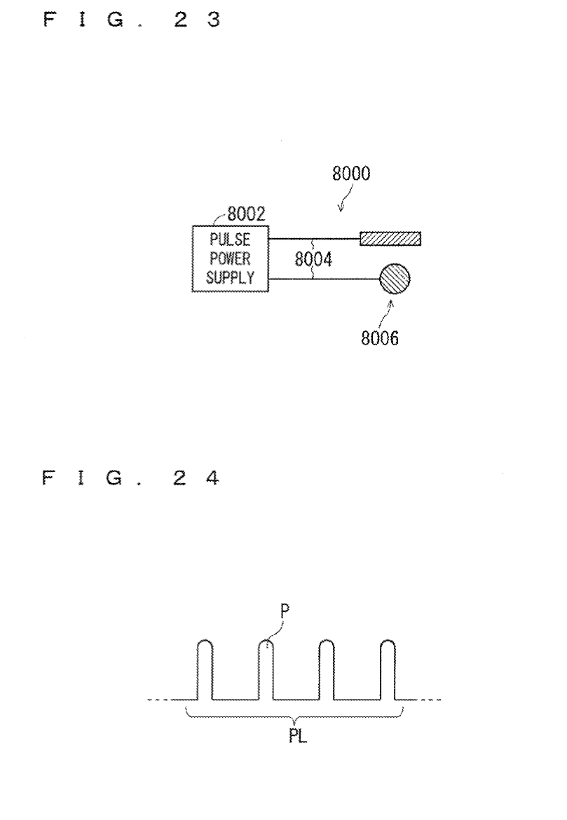

As shown in FIG. 23, an ignition device 8000 includes a pulse power supply 8002, a cable 8004, and an electrode structure 8006. Any of the electrode structures according to the other preferred embodiments is adopted as the electrode structure 8006. The pulse power supply 8002 and the electrode structure 8006 are connected to each other through the cable 8004. A pulse voltage generated by the pulse power supply 8002 is supplied, through the cable 8004 which is a transmission line, between the anode and the cathode.

Although no particular limitation is put on the type of the pulse power supply 8002, it is desirable to use an inductive energy storage type which generates a pulse voltage by emitting inductive energy stored in an inductive element such as an inductor or a transformer. This is because a pulse power supply of the inductive energy storage type can supply a significantly large amount of energy.

FIG. 24 is a diagram schematically showing a waveform of a pulse train applied between the anode and the cathode. In each of pulses P of a pulse train PL, the predischarge DIS1 and the main discharge DIS2 described above occur to generate a flame. Therefore, the application of the pulse train causes an ignition in each pulse.

While the present invention has been described in detail, the foregoing description is in all aspects illustrative and not restrictive. Therefore, it is to be understood that numerous variations and modifications may be made without departing from the scope of the present invention. Particularly, a combination of a technical matter according to one preferred embodiment with a technical matter according to another preferred embodiment is, of course, contemplated.

What is claimed is:

1. A method for igniting an air-fuel mixture that fills a combustion space provided in a combustion vessel of an internal combustion engine,
said method comprising the steps of:
(a) mounting an electrode structure in said combustion vessel;
(b) after said step (a), generating a predischarge; and
(c) subsequent to said step (b), generating a main discharge.
wherein
said electrode structure comprises:
a first electrode made of a conductive material and having a rod-like shape, said first electrode protruding from an inner surface of said combustion vessel; and
a first dielectric barrier made of a dielectric material,
said first electrode has, on a surface thereof:
a first exposed surface exposed in said combustion space; and
a first coated surface coated with said first dielectric barrier,
in said step (b), said predischarge progresses while said first coated surface serves as a start point or an end point of the progress,
in said step (c), said main discharge including a creeping discharge that creeps along a surface of said first dielectric barrier and going through a spatial region where said predischarge occurs progresses while said first exposed surface serves as a start point or an end point of the progress.

2. The method according to claim 1, wherein
said electrode structure further comprises:
a second electrode made of a conductive material;
a third electrode made of a conductive material; and
a second dielectric barrier made of a dielectric material,
said second electrode has, on a surface thereof, a second exposed surface exposed in said combustion space,
said third electrode has, on a surface thereof, a second coated surface coated with said second dielectric barrier,
in said step (b), said predischarge progresses between said first coated surface and said second coated surface,
in said step (c), said main discharge further including a creeping discharge that creeps along a surface of said second dielectric barrier progresses between said first exposed surface and said second exposed surface.

3. The method according to claim 1, wherein
said electrode structure further comprises a second electrode made of a conductive material,
said second electrode has, on a surface thereof, a second exposed surface exposed in said combustion space,
in said step (b), said predischarge progresses between said first coated surface and said second exposed surface,
in said step (c), said main discharge progresses between said first exposed surface and said second exposed surface.

4. The method according to claim 1, wherein
said electrode structure thither comprises:
a second electrode made of a conductive material; and
a second dielectric barrier made of a dielectric material,
said second electrode has, on a surface thereof:
a second exposed surface exposed in said combustion space; and
a second coated surface coated with said second dielectric barrier,
in said step (b), said predischarge progresses between said first coated surface and said second coated surface,
in said step (c), said main discharge further including a creeping discharge that creeps along a surface of said second dielectric harrier progresses between said first exposed surface and said second exposed surface.

5. The method according to claim 1, wherein
said electrode structure further comprises:
a second electrode made of a conductive material; and
a second dielectric barrier made of a dielectric material,
said combustion vessel has, on an inner surface thereof, a second exposed surface exposed in said combustion space,
said second electrode has, on a surface thereof, a second coated surface coated with said second dielectric barrier,
in said step (b), said predischarge progresses between said first coated surface and said second coated surface,
in said step (c), said main discharge further including a creeping discharge that creeps along a surface of said second dielectric barrier progresses between said first exposed surface and said second exposed surface.

6. The method according to claim 1 wherein
said combustion vessel has, on an inner surface thereof, a second exposed surface exposed in said combustion space,
in said step (b), said predischarge progresses between said first coated surface and said second exposed surface,
in said step (c), said main discharge progresses between said first exposed surface and said second exposed surface.

7. The method according to claim 1, wherein
said predischarge is a streamer discharge, and said main discharge is an arc discharge.

8. The method according to claim 2, wherein
said predischarge is a streamer discharge, and said main discharge is an arc discharge.

9. The method according to claim 3, wherein
said predischarge is a streamer discharge, and said main discharge is an arc discharge.

10. The method according to claim 4, wherein
said predischarge is a streamer discharge, and said main discharge is an arc discharge.

11. The method according to claim 5, wherein
said predischarge is a streamer discharge, and said main discharge is an arc discharge.

12. The method according to claim 6, wherein
said predischarge is a streamer discharge, and said main discharge is an arc discharge.
